(19) United States
(12) Patent Application Publication
(10) Pub. No.: US 2008/0100427 A1
(43) Pub. Date: May 1, 2008

(54) CONFIGURABLE PROTOCOL IDENTIFICATION DEVICE

(75) Inventors: Tejas B. Desai, Troy, MI (US); Patricia Kachouh, Sterling Heights, MI (US); Gerald Ostrander, Davison, MI (US); Brian Marlett, Macomb, MI (US); Scott Lucy, Lake Orion, MI (US)

Correspondence Address: SIEMENS CORPORATION;INTELLECTUAL PROPERTY LAW DEPARTMENT, 170 WOOD AVENUE SOUTH, attn: SV-CONTI TRANSITION, ISELIN, NJ, 08830, US

(73) Assignee: SIEMENS VDO AUTOMOTIVE CORPORATION, Auburn Hills, MI (US)

(21) Appl. No.: 11/924,028

(22) Filed: Oct. 25, 2007

Related U.S. Application Data
(60) Provisional application No. 60/854,251, filed on Oct. 25, 2006.
(60) Provisional application No. 60/881,763, filed on Jan. 22, 2007.
(60) Provisional application No. 60/881,766, filed on Jan. 22, 2007.

(51) Int. Cl. B60R 25/10

(52) U.S. Cl. 340/426.36

(57) ABSTRACT

An identification device is user configurable to communicate according to different communication protocols. Once the identification device has been set to a desired communication protocol where all it will immediately transmit an identification code to the corresponding vehicle controller such that the vehicle controller will learn the identification code and be able to recognize subsequent transmissions and authenticate the identification device.

### CROSS REFERENCE TO RELATED APPLICATION

The application claims priority to U.S. Provisional Application No. 60/854,251 which was filed on Oct. 25, 2006, 60/881,763 which was filed Jan. 22, 2007 and 60/881,766 which was filed on Jan. 22, 2007.

### BACKGROUND OF THE INVENTION

This invention generally relates to passive entry and start system for a motor vehicle. More particularly this invention relates to a communication protocol configuration for a remote identification device.

A passive entry and start system includes a remote authorization device that communicates with a control module within a vehicle. The identification device and the control module within the vehicle communicate using a specified protocol with a unique identification code. Different systems utilize different protocols and therefore identification devices from different systems are not compatible.

### SUMMARY OF THE INVENTION

An example identification device includes at least two user selectable communication protocols that provide for the use with differently configured receivers.

The identification device includes a non-volatile memory device that includes instructions for transmitting according to at least two different communication protocols. The identification device can be selected by a user to operate and communicate according to one of the two stored communication protocols. The selection between communication protocols is accomplished through a desired sequence of button actuation.

These and other features of the present invention can be best understood from the following specification and drawings, the following of which is a brief description.

### BRIEF DESCRIPTION OF THE DRAWINGS

FIG. 1 is a schematic representation of an example keyless remote entry system.

FIG. 2 is a schematic representation of the identification device and two vehicle controllers operating according to different communication protocols.

FIG. 3 is a flow diagram illustrating the example method.

### DETAILED DESCRIPTION OF THE PREFERRED EMBODIMENT

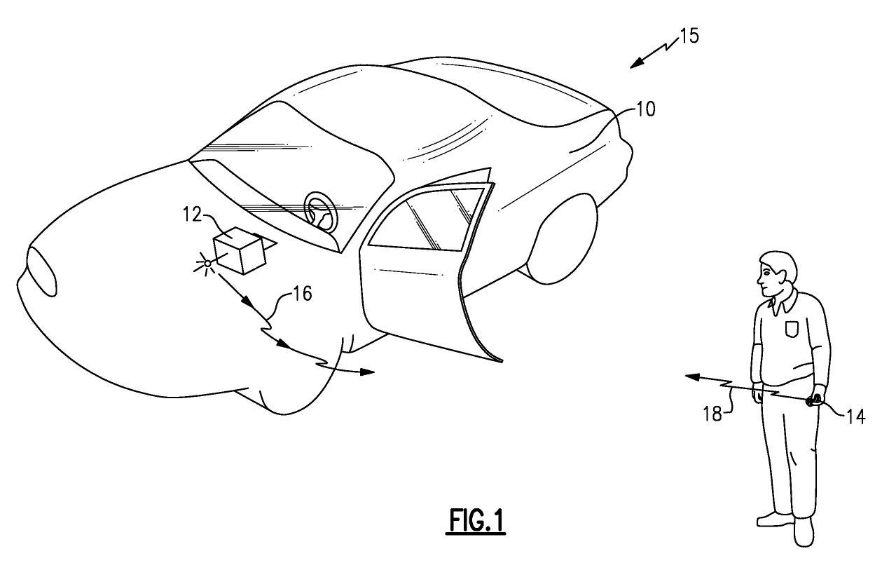

Referring to FIG. 1, a vehicle 10 includes a controller 12 that is part of a remote keyless entry system 15. The remote keyless entry system 15 utilizes an identification device 14 to communicate with a controller 12 within the vehicle 10. The controller 12 operates according to a defined communication protocol. This communication protocol provides instructions and format for the signal 16 sent from the controller 12 and received by the identification device 14. Similarly, the identification device 14 also operates according to this transmission protocol and sends signals 18 that are received by the controller 12.

As appreciated, different vehicles 10 will include different controllers that operate according to different transmission protocols. However, the example identification device 14 is operable with many different controllers as it includes several different transmission protocols. These transmission protocols within the identification device 14 are selected by the user such that the identification device 14 can be set up and utilized with several different vehicles.

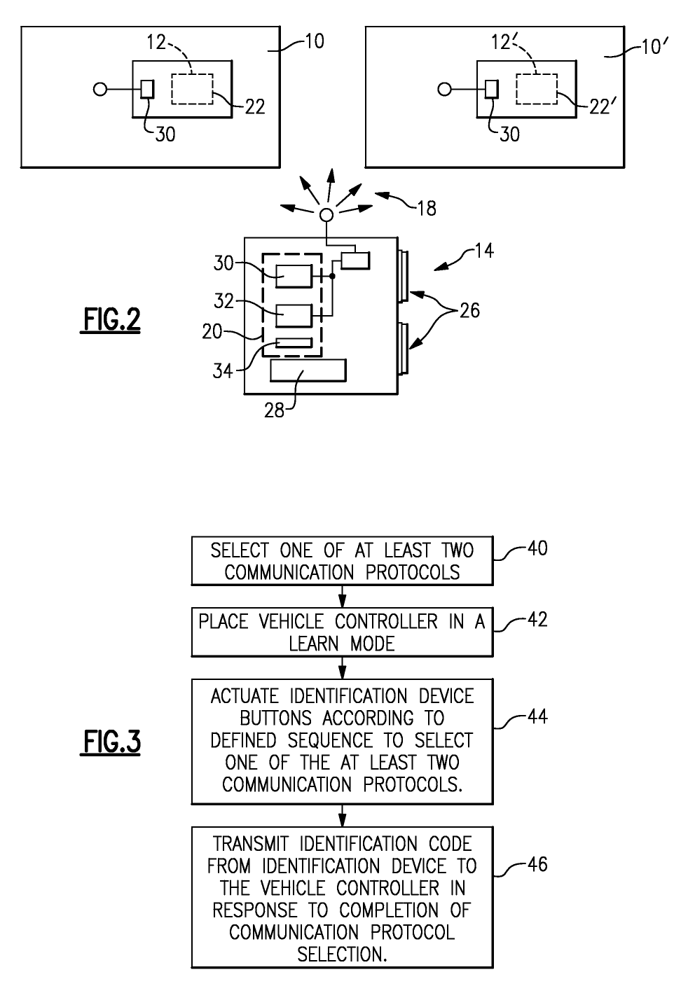

Referring to FIG. 2, the vehicle 10 includes the controller 12 that in turn includes a memory device 22. The controller 12 operates according to a communication protocol schematically indicated at 30. This communication protocol is different than that of a second controller 12′ within a second vehicle 10′. The second communication protocol 32 is different than the first protocol 30 of the first controller 12. The second controller 12′ includes a memory location 22′.

The example identification device 14 includes a memory device 20 that has stored instructions for transmitting and operating according to the first protocol 30 or the second protocol 32. The identification device 14 will only operate in one of the two protocols 30, 32 at any one time. However, the identification device 14 is selectable by a user such that it can be set to be utilized with either the first vehicle 10 or the second vehicle 10′.

The identification device includes actuateable buttons 26 and is powered by a battery 28. A defined sequence of button presses 26 is utilized to select or switch between one of the two protocols 30, 32 that are stored within in the memory device 20. The example memory device is a non-volatile memory that enables the identification device 14 to maintain the desired communication protocol during battery replacement or other power absences.

Actuation of the buttons 26 to select between the different selectable communication protocols 30, 32 can be as simple as a combination of the buttons pressed within a desired time period. Further, more complex sequences could involve the removal of the battery 28 followed by a desired button combination after a period after replacement of the battery.

The identification device 14 also provides for a learning procedure for which an identification code 34 stored within the non-volatile memory 20 is transmitted immediately after selection of one of the at least two protocols. 30, 32. In the example, identification device 14 the identification code 34 is transmitted responsive to the selection process for the communication protocol.

Referring to FIG. 3, this process is schematically illustrated and includes the initial step 40 of selecting one of the at least two communication protocols for which the identification device will operate. The controller or other module within the vehicle is set and placed into a learn mode where it is capable of receiving, accepting and restoring identification codes from various identification devices as indicated at step 42. Once the vehicle controller is placed in a learn mode, the identification device is actuated as indicated at step 44 according to a defined sequence to select which of the two communication protocols that are compatible and correspond with the desired vehicle controller. Once this process is complete, the identification device 14 will automatically transmit an identification code to the vehicle controller as indicated at 46, so that the vehicle controller 12 may receive that transmission and retain the identification code within the controller memory 22 for later use.

Accordingly, the example identification device and method of selecting a communication protocol of this identification device provides for the easy selection and programming of an identification device without the use of tools or other specialized devices.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of preparing an identification device for communication with a keyless entry system comprising the steps of:
a) determining which of at least two communication protocols are desired for communication with the keyless entry system; and
b) manipulating physical features of the identification device in a defined order to select the determined one of the at least two communication protocols.

2. The method as recited in claim 1, including the step of sending an identification code unique to the identification device to a receiver of the keyless entry system and storing the identification code for authorizing use of the identification device with the keyless entry system.

3. The method as recited in claim 2, wherein the step of sending the identification code occurs immediately in response to selection of the determined one of the at least two communication protocols.

4. The method as recited in claim 3, including the step of placing the keyless entry system in a condition ready to learn the identification code prior to step b.

5. The method as recited in claim 1, wherein said step b comprises depressing buttons disposed on the identification device.

6. The method as recited in claim 1, wherein said step b comprises removing a battery from the identification device.

7. The method as recited in claim 1, including the step of storing the at least two communication protocols in a non-volatile memory device of the identification device.

8. The method as recited in claim 7, wherein the determined one of the at least two communication protocols governs identification device transmissions until a change in identification protocols is made by manipulating physical features of the identification according to the defined order.

9. A identification device for a keyless entry system comprising:
a non-volatile memory device for storing instruction for transmission of at least two different communication protocols;
a transmitter for sending and receiving signals according to a selected one of the at least two different communication protocols; and
a selectively actuateable device for selecting one of the at least two different communication protocols.

10. The identification device as recited in claim 9, wherein the identification device transmits an identification code responsive to the selection of one of the at least two different communication protocols.

11. The identification device as recited in claim 9, wherein the selectively actuateable device comprises at least one button.

12. The identification device as recited in claim 11, wherein the at least one button is actuated according to a defined sequence for selecting between the at least two different communication protocols.

13. A keyless entry system of a motor vehicle comprising:
a module for mounting within a vehicle including a memory device and a receiver; and
an identification device for communicating with the module, the identification device operable to communicate with the module according to at one of at least two user selectable communication protocols.

14. The keyless entry system as recited in claim 13, wherein the identification device includes a non-volatile memory device for storing the at least two user selectable communication protocols.

15. The keyless entry system as recited in claim 13, wherein the identification device transmits an identification code to the module responsive to selecting one of the at least two user selectable communication protocols.

16. The keyless entry system as recited in claim 13, wherein the identification device includes at least one button that is actuateable according to a defined sequence to selected one of the at least two user selectable communication protocols.
